(19) United States
(12) Patent Application Publication
(10) Pub. No.: US 2021/0273888 A1
(43) Pub. Date: Sep. 2, 2021

(54) Method and Communication Device for Controlling Reception of Data

(71) Applicant: Telefonaktiebolaget LM Ericsson (publ), Stockholm (SE)

(72) Inventors: Selim Ickin, Stocksund (SE); Gunilla Berndtsson, Nacka (SE); Xiaoyu Lan, Täby (SE); David Lindegren, Luleå (SE)

(21) Appl. No.: 17/258,285

(22) PCT Filed: Aug. 24, 2018
(86) PCT No.: PCT/SE2018/050854

§ 371 Date: Jan. 6, 2021

(51) Int. Cl. H04L 12/825; H04L 12/813; H04L 12/841

(52) U.S. Cl. CPC H04L 47/263; H04W 28/10; H04L 47/28; H04L 47/20

(57) ABSTRACT

A method and a communication device (200) for controlling reception of data when a maximum total amount of received data is stipulated for a time period. An amount of data received during said time period is monitored (2:5) and compared with a predicted distribution of data (200A) that the device (200) is expected to receive without exceeding the maximum total amount. An amount of requested data is then reduced (2:6, 2:7) when detecting that the monitored amount of received data exceeds the predicted distribution of data, so that the maximum total amount of data will not be exceeded before the time period expires.

### TECHNICAL FIELD

The present disclosure relates generally to a method and a communication device, for controlling reception of data in the communication device when a maximum total amount of received data is prescribed or stipulated for a time period.

### BACKGROUND

In the field of data communication, the data consumption when applications and services are employed in communication devices has increased substantially in recent years due to increased quality and resolution in multimedia services, increased variety and range of available multimedia content, as well as a growing number of web components involved when browsing the Internet. Also, the time an average user spends on surfing the Internet and consuming content on their communication devices, either by streaming or downloading, has grown immensely which naturally also increases the amounts of data that are transmitted over communication networks. All these factors contribute to an ever increasing load on the networks, which is particularly critical in wireless networks which have limited resources on the radio interface.

As a result, network operators and service providers usually set a limit for how much data a communication device is allowed to receive during a given time period, typically per month according to a subscription dependent monthly data plan. If the data limit is reached before the end of the month, data reception is halted for the device and its user is usually given the possibility to pay an additional sum to resume the data traffic to the device. The user may also experience significantly lower quality due to reduced bandwidth when the stipulated data limit is approaching. Sometimes the user is able to use a “higher” subscription with higher data limit thus allowing for more data consumption, although to a higher cost.

There are also solutions available which delay delivery of data until the device is connected to an alternative network such as WiFi, and this may be useful for some applications such as downloading of non-delay sensitive information but not for others such as streaming of films and music or interactive applications. The user has also often the possibility to choose a “light weight” version of some desirable content, typically involving reduced resolution, which requires less data than its full version, in order to prolong the data usage within the monthly data plan without extra cost.

However, the solutions mentioned above for handling consumption of data in a communication device when reception of a maximum amount of data is stipulated for a certain time period, are associated with various problems. For example, it may be necessary that the user is aware of how much data is left at any time and can plan the data consumption accordingly and/or is prepared to take increased costs. In either case, certain operations by the user are typically required and the user may manually set a data amount threshold for when a warning should be issued, or when the resolution of requested data should be reduced, or when the application used should be switched-off altogether. The user may also, as mentioned above, choose a light weight version if available, or simply refrain from consuming some desirable data-intense content, when noting that the data limit is approaching. All the above options thus require user actions and/or higher costs as well as awareness of how much data can be consumed.

### SUMMARY

It is an object of embodiments described herein to address at least some of the problems and issues outlined above. It is possible to achieve this object and others by using a method and a communication device as defined in the attached independent claims.

According to one aspect, a method is performed for controlling reception of data in a communication device when a maximum total amount of received data is stipulated for a time period. This method comprises obtaining a predicted distribution of data that the communication device is expected to receive over said time period without exceeding said maximum total amount of data. The method further comprises monitoring an amount of data received during said time period, and reducing an amount of requested data when detecting that the monitored amount of received data exceeds the predicted distribution of data, so that the maximum total amount of received data will not be exceeded before said time period expires.

According to another aspect, a communication device is arranged to control reception of data in the communication device when a maximum total amount of received data is stipulated for a time period. The communication device is configured to obtain a predicted distribution of data that the communication device is expected to receive over said time period without exceeding said maximum total amount of data. The communication device is also configured to monitor an amount of data received during said time period, and to reduce an amount of requested data when detecting that the monitored amount of received data exceeds the predicted distribution of data, so that the maximum total amount of received data will not be exceeded before said time period expires.

When employing any of the above method and apparatus, it is an advantage that the risk of reaching and exceeding the data limit before expiry of the time period can be reduced without requiring any actions or awareness from the user. The above method and communication device may be configured and implemented according to different optional embodiments to accomplish further features and benefits, to be described below.

A computer program is also provided comprising instructions which, when executed on at least one processor in the above communication device, cause the at least one processor to carry out the method described above. A carrier is also provided which contains the above computer program, wherein the carrier is one of an electronic signal, an optical signal, a radio signal, or a computer readable storage medium.

### BRIEF DESCRIPTION OF DRAWINGS

The solution will now be described in more detail by means of exemplary embodiments and with reference to the accompanying drawings, in which:

FIG. 1 is a communication scenario illustrating how a communication device may receive data, where embodiments described herein may be employed.

FIG. 2 is a communication scenario illustrating an example of how the solution may be employed in a communication device, according to some example embodiments.

FIG. 3 is a flow chart illustrating a procedure that may be performed in a communication device, according to further example embodiments.

FIG. 4 is a flow chart illustrating an example of how the procedure in FIG. 3 may be performed in more detail, according to further example embodiments.

FIG. 5 is a diagram illustrating an example of a registered data reception pattern per week.

FIG. 6 is a table with a suggested data consumption per week.

FIG. 7 is a diagram illustrating how the suggested data consumption can be accumulated during a week when the table in FIG. 6 is applied.

FIG. 7A is a diagram illustrating an actual data consumption compared to the suggested data consumption of FIG. 7.

FIG. 8 is a block diagram illustrating how a communication device may be structured, according to further example embodiments.

### DETAILED DESCRIPTION

Briefly described, a solution is provided to enable improved or even optimized consumption of data in a communication device when a maximum total amount of received data is prescribed or stipulated for a certain time period. In other words, this means basically that the maximum total amount of received data should not be exceeded before the time period has expired, e.g. according to a subscription or other agreement, and the communication device user is thus allowed to consume up to the maximum amount of data per time period, typically a month. In the context of this description, the terms “data consumption” and “data reception” are basically equal and interchangeable and it is assumed that any data received by the device is “consumed” in some respect.

The solution is useful to make sure that the maximum amount of data is not exceeded in any such time period by automatically reducing an amount of requested data whenever detecting that a monitored amount of received data exceeds a predicted distribution of data reception over the time period, herein generally referred to as “excessive data consumption”. The predicted distribution of data reception can be obtained by means of a machine learning function applied on data previously received by the device, which function learns how the data consumption can be expected to vary over the time period. For example, the data consumption may be different during different days of the week so as to form a repeated consumption pattern that can be identified by the machine learning function.

The above detection and reduction of requested data can be performed automatically by the communication device without requiring any awareness of remaining data amount nor actions by the user and without generating increased costs. To achieve these advantages the communication device can operate as follows.

FIG. 1 is a simplified illustration of how a communication device 100 may receive requested data from various data sources 102 such as content servers or the like, where the data is transported over a schematically shown communication network 104 which in practice may include any number of public and/or local networks. In some illustrative but non-limiting examples, the communication device 100 may be a smartphone, a tablet, a streaming device or a television receiver, and the communication network 104 may include a fixed or wireless network used for accessing the Internet. The examples and features described herein may be employed in the communication scenario shown in FIG. 1 which is however not limited to any particular types of communication device, communication network and data sources. Further, a user may employ more than one communication device for consuming data within the stipulated maximum amount of data, although only one device is employed in the examples herein for simplicity. In the case of multiple devices, their amounts of received data need to be added together at a suitable entity, e.g. one of the devices.

It is assumed that the communication device 100 fetches and receives data upon request, typically when a user enters a command for downloading or streaming some desired data from a content provider or the like, herein generally referred to as a data source. This request could also be a subscription to a podcast or the like. Some non-limiting typical examples of data include digitally encoded movies, music and web pages. It is further assumed that a maximum total amount of received data is stipulated for a certain time period, which means that the amount of data the communication device is allowed to receive and consume during the time period is limited, e.g. as prescribed or required in a subscription or other service agreement. In other words, it can be said that a maximum total data limit is compulsory for the time period.

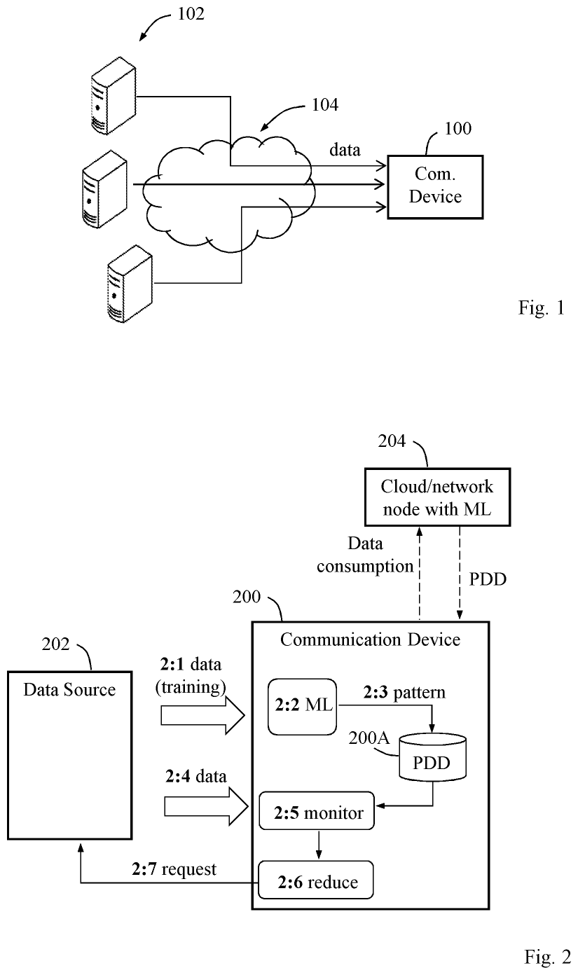

An example of how the solution may be employed in a communication device will now be described with reference to FIG. 2 which shows some operations that may be performed by the communication device 200 and/or by a node associated with a communication network which may be implemented in the network or in a cloud-like environment, here schematically illustrated as a “cloud/network node” 204. In this simplified example, the communication device 200 requests and receives data from a data source 202 which in practice may comprise any number of individual data sources such as content servers or the like. First, a predicted distribution of data amount usually received over said time period is identified based on a data consumption behavior which can be observed and measured basically in a training phase or training procedure while the communication device 200 fetches and thus receives data from the data source 202, or from several ones, as illustrated by an action 2:1.

The distribution of received data may follow a certain predictable repeated pattern across the time period, e.g. per day of the week, which is determined by the user's consumption habits which can be identified simply by measuring the amount of data received by the communication device 200 over time. Such measurements may be made during several repeated time periods of a given length, i.e. the “time period” mentioned herein. The measurement results may then be averaged for each day of the week in a suitable manner to form a general Predicted Distribution of Data, PDD, which may thus display variations of the received data on a daily basis. The days of the week are used in this description as suitable measurement intervals in which to determine the data consumption, although it is possible to make other divisions as well. For example, each day may be further divided into shorter intervals such as 0-9 am, 9 am-3 pm and 3-12 pm so that the data consumption is accordingly predicted for 3×7=21 intervals per week to form the PDD.

The PDD may be determined by applying a machine learning algorithm “ML” on the measured amounts of received data, as illustrated by an action 2:2. The communication device 200 itself may apply the ML and use the resulting PDD for detecting excessive data consumption, as shown in the figure. Alternatively, the cloud/network node 204 may apply the ML based on measurements of data consumption provided by the communication device 200, and the latter may then get the resulting PDD from the cloud/network node 204, as shown by dashed arrows. In another alternative, the cloud/network node 204 may both apply the ML to determine the PDD and compare the PDD with further data consumption measurements from the device to detect excessive data consumption which could then be signaled to the device 200.

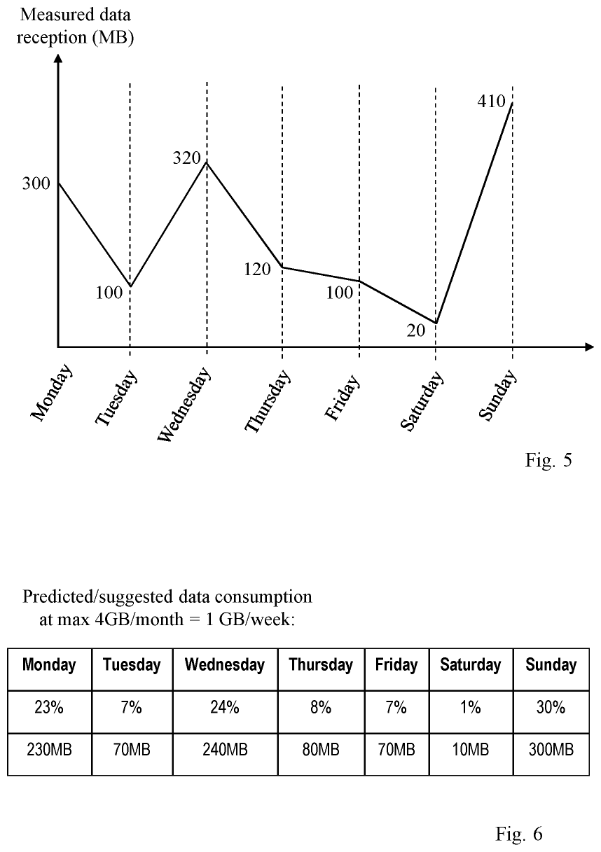

An average received data amount may thus be calculated for each day of the week, or for any other chosen measurement intervals, based on the above measurements. An example of how a predicted distribution of data PDD may look like will be described later below referring to FIGS. 5-7 where the received data amount varies from day to day. For example, such measurements may reveal that the user habitually consumes a certain amount of data on Mondays and another smaller amount of data on Tuesdays, and so forth. The solution is also applicable when the user consumes roughly the same amount during all seven days of the week, and also in case the data consumption does not follow any discernible habitual pattern by assuming that a certain default data amount can be expected to be consumed more or less each day. It should be noted that the PDD indicates the amount of data that the communication device is expected to receive without exceeding the maximum total amount of data before time period expires, meaning that the training phase is implemented when the user consumes no more data than allowed within the entire time period.

The outcome of the ML in action 2:2 is the PDD which basically indicates a data reception or consumption pattern in action 2:3, and the PDD is stored in a memory 200A or the like for later use. Once the PDD has been identified and saved, it can be used for controlling further data consumption as received in another action 2:4. It should be noted that the ML may be further trained at the same time the PDD is actually used for controlling data reception, so that actions 2:1 and 2:4 may more or less coincide. This way, the PDD can be improved and/or updated based on further measurements, e.g. in case the user changes his/her data consumption habits.

Another action 2:5 illustrates that the data reception in 2:4 is monitored with respect to the PDD, which means that the actual data reception is compared to the predicted data reception according to the PDD to detect any deviations. If it is found that the monitored amount of received data basically exceeds the predicted distribution of data, e.g. by a certain margin, it can be deduced that the maximum total amount of received data may be exceeded before said time period expires. To avoid this, the communication device 200 decides to actively reduce the amount of requested data, as shown by actions 2:6 and 2:7, so that less data will be received and the monitored amount of received data will better conform to the predicted distribution of data. Thereby, the risk of reaching and exceeding the data limit before expiry of the time period will be reduced automatically. It is thus an advantage that the above risk is automatically reduced without requiring any actions or awareness from the user.

There may also be a data saving function implemented in the communication device 200 that can be either active to apply the reducing of requested data once excessive data consumption is detected, or inactive to turn off the reduction of requested data when no limitations are desired. It may be suitable that the user needs to deactivate the data saving function which is otherwise always active. This function thus gives the user the possibility to decide whether a particular downloading or streaming operation should be affected by reduction of requested data or not. There may further be multiple selectable levels of data reduction that determine to what extent, i.e. how much, the requested data shall be reduced which may impact the user experience.

There are several ways of reducing the amount of requested data once detecting that the monitored amount of received data exceeds the predicted distribution of data. In some non-limiting but illustrative examples, reducing the amount of requested data may comprise at least one of the following alternatives 1-5. It should be noted that any number of the below alternatives 1-5 may be combined and employed at the same time where appropriate.
1) Requesting data with reduced bitrate, e.g. in order to reduce the number of packets that must be received by the device 200. For example, a stripped-down version of some content selected by the user may be automatically requested instead of the full version. Some example of this could be requesting a movie with reduced quality or a web page without images.
2) Requesting compressed data, e.g. as packaged in a zipped format or the like in the case of text or image content. Then the device may be able to decompress the received compressed data before playout so that no data is lost.
3) Requesting only relevant data while omitting non-relevant data. In this context, “non-relevant data” should be understood as any data that does not notably contribute to the user's experience of data consumption, e.g. some requested content, which may include enjoyment and/or comprehension thereof. An illustrative example may be omitting added information not related to the actual content such as advertisements or notifications which are deemed irrelevant to the user in view of the desired data/content.
4) Requesting data with reduced resolution, e.g. the communication device 200 may automatically request some video content with lower visual and/or audio resolution than the highest resolution available.
5) Notifying a user to restrict consumption of data, which means that the user is more likely to be sparing and selective when selecting content to download or stream after such a warning. This alternative may be implemented by displaying some suitable alert on the screen or the like and/or by emitting a recognizable warning audio signal.

As mentioned above, the above-described procedure may be modified by implementing at least some of the actions in the cloud/network node 204 instead of in the communication device 200. For example, the device 200 may perform measurements of received data in action 2:1 and provide them to the cloud/network node 204 which then can perform actions 2:2 and 2:3 and possibly also the monitoring in action 2:5 after which a notification can be issued to the device 200 if excessive data consumption is detected, to trigger reducing of the amount of requested data in action 2:6.

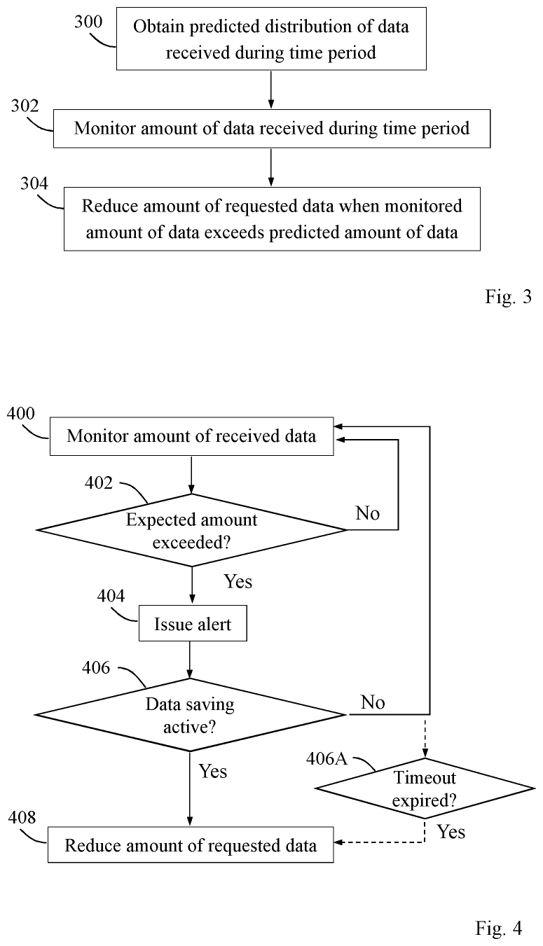

An example of how the solution may be employed in terms of actions which may be performed by a communication device such as the communication device 200, is illustrated by the flow chart in FIG. 3 which will now be described with further reference to FIG. 2, although this procedure is not limited to the example of FIG. 2. The actions in FIG. 3 could thus be performed for controlling reception of data in a communication device 200 when a maximum total amount of received data is stipulated for a time period that may have been specified or predefined, e.g. according to a subscription or other agreement. The actions in FIG. 3 could thus be performed by the communication device 200 or at least partly by a cloud/network node 204 associated with a communication network used for communicating data to the communication device 200.

A first action 300 illustrates obtaining a predicted distribution of data, i.e. the above-described PDD, that the communication device is expected to receive over said time period without exceeding said maximum total amount of data. It was described above how machine learning may be used to determine the PDD.

In a next action 302, an amount of data received during said time period is monitored. The monitored received data amount is compared to the predicted distribution of data obtained in action 300, and as long as the received data amount does not significantly exceed the predicted distribution of data it is not necessary to take any actions to reduce or limit the amount of requested data. Otherwise the next action 304 is performed as follows.

Action 304 illustrates that an amount of requested data is reduced when detecting that the monitored amount of received data exceeds the predicted distribution of data, so that the maximum total amount of received data will not be exceeded before said time period expires. Thereby, the risk of reaching and exceeding the data limit before expiry of the time period will be reduced automatically. Some examples of how the amount of requested data can be reduced have been described above.

Some further examples of embodiments that may be employed in the above procedure in FIG. 3 will now be described. In some example embodiments, reducing the amount of requested data may comprise at least one of: 1) requesting data with reduced bitrate, 2) requesting compressed data, 3) requesting only relevant data while omitting non-relevant data, 4) requesting data with reduced resolution, 5) notifying a user to restrict consumption of data. These options have been described in more detail above.

In another example embodiment, said predicted distribution of data may be obtained by applying a machine learning algorithm on previously received amounts of data. The usage of machine learning in this context has been described above with reference to actions 2:2-2:3.

In another alternative embodiment, said predicted distribution of data may instead be obtained from a cloud or network node 204 where a machine learning algorithm is applied on previously received amounts of data.

In another example embodiment, the amount of requested data may be reduced when detecting that the monitored amount of received data exceeds the predicted distribution of data by a certain margin. Thereby, the data saving will not be implemented at too small deviations from the PDD obtained in action 300 which thus do not suggest any significant risk of excessive data consumption. Any fluctuations between active and inactive data saving in a “ping-pong” manner can also be avoided when using a suitable margin in this embodiment.

In further example embodiments, said predicted distribution of data may comprise an expected amount of received data per individual day during the time period, and said time period may have a duration of one month, as in the examples illustrated in FIGS. 5-7A. A monthly data plan for data consumption is quite common in subscriptions and agreements in this field so that this embodiments mostly useful in practice.

In another example embodiment, the communication device may issue an alert, such as a visual indication and/or a sound, to notify the user that the maximum total amount of received data is likely to be exceeded before the time period expires. This effectively provides a “warning” to the user to be more restrictive and economic when consuming data and content.

When the latter embodiment is used, another example embodiment may be that said alert indicates an amount of remaining data that can be received until the time period expires without exceeding the stipulated maximum amount of data. This embodiment may be implemented as a “remaining data indicator” or the like which may display a current status including how much data is left to consume until the time period expires, e.g. a percentage P of the total available data amount. The displayed status may also include a percentage T of how much time remains of the total time period so that the user can adapt his/her data consumption accordingly. As an example, the remaining data indicator may display that P=85% data is left and T=75% time remains.

In another example embodiment, said reducing of the amount of requested data may be performed when a data saving function in the communication device is active, i.e. it has not been deactivated by the user. This possible feature has also been described above. When the latter embodiment is used, further example embodiments may include that the data saving function comprises multiple selectable levels of data reduction determining how much requested data to reduce, and that the data saving function may be offered by the communication device as a visual and/or audio indication. Thereby, it is up to the user to apply the above-described action 304 and to what extent. After deactivation by the user, the data saving function may be automatically activated again after a preset timeout period, in case the user forgets to do it.

As mentioned above, further example embodiments may be that the above actions are, at least partly, performed by the communication device 200 or by a cloud or network node 204.

An example of how the procedure in FIG. 3 may be realized in practice will now be described with reference to the flow chart in FIG. 4. It is assumed that a useful PDD has already been obtained as of action 300 which indicates the expected daily data consumption, and the PDD is now applied on further data consumption at the communication device 200. It is also assumed that the days of the week are used as measurement intervals so that the PDD reflects the daily data consumption pattern, e.g. as an accumulated data consumption during the course of the time period. In a first action 400, the amount of received data is more or less constantly monitored per measurement interval, i.e. day, during the above-mentioned time period, which corresponds to action 302. In this action, the amount of received data is thus measured in the measurement intervals and the PDD is compared with the measured daily data consumption on a daily basis.

Another action 402 illustrates that it is determined, after each day, whether the measured data consumption so far accumulated over the time period exceeds the expected/predicted accumulated data consumption indicated by the PDD. If not, no measures are taken and the procedure returns to action 400 and continues the monitoring during the next measurement interval. If it is determined in action 402 that the measured accumulated data consumption does exceed the accumulated data consumption according to the PDD, an alert is issued in an action 404, to notify the user that there is a risk that the stipulated maximum total amount of data will be exceeded before the time period expires.

It is then checked if the above-described data saving function is active or not, in another action 406. If so, the amount of requested data is reduced in action 408 which corresponds to the above-described action 304. If data saving function is not active, e.g. after deactivation by the user, no reduction of requested data is applied and the procedure returns to action 400 for monitoring the data consumption in the next measurement interval. It was mentioned above that the data saving function may be automatically activated after a preset timeout period of deactivation, which is schematically indicated by an action 406A, so that action 408 can be performed anyway at some point after the expected data amount has been exceeded in action 402.

It should be noted that all actions in FIG. 4 may be performed by the device 200 itself. It is also possible that the above-described cloud/network node 204 may perform actions 400-402 based on measurements from the device 200, and send a notification to the device 200 if Yes in 402, to trigger the reduction of requested data.

An example of how the amount of received and consumed data per day may vary over a week is illustrated in the diagram of FIG. 5. The data reception is measured by the communication device 200 and the number of received megabytes, MB, per day is shown. These measurements may be made a number of weeks to capture the daily consumption pattern and the shown measurements may thus represent an average of several measured weeks.

It can be seen that the device has received on average 300 MB on Mondays, 100 MB on Tuesdays, 320 MB on Wednesdays, and so forth. It can thus be seen that in FIG. 5 the total average data consumption over a week is

300+100+320+120+100+20+410=1370 MB.

Given this pattern of measured data consumption, and in case the maximum total amount of data per month is 4 Gigabyte, GB, which roughly corresponds to 1 GB per week, the PDD may be determined as shown in FIG. 6.

The distributed data consumption according to FIG. 6 has been determined according to relative percentages of the measured data amounts of FIG. 5 so that the predicted/suggested data consumption per week equals 1000 MB=1 GB. Hence, to follow the distribution pattern in FIG. 5, the data consumption on Monday can be 23% of the weekly available data amount, Tuesday 7%, Wednesday 24%, and so forth. In order to not exceed 1 GB per week, these percentages correspond to a maximum of 230 MB on Monday, 70 MB on Tuesday, 240 MB on Wednesday, and so forth, thus adding up to 1000 MB.

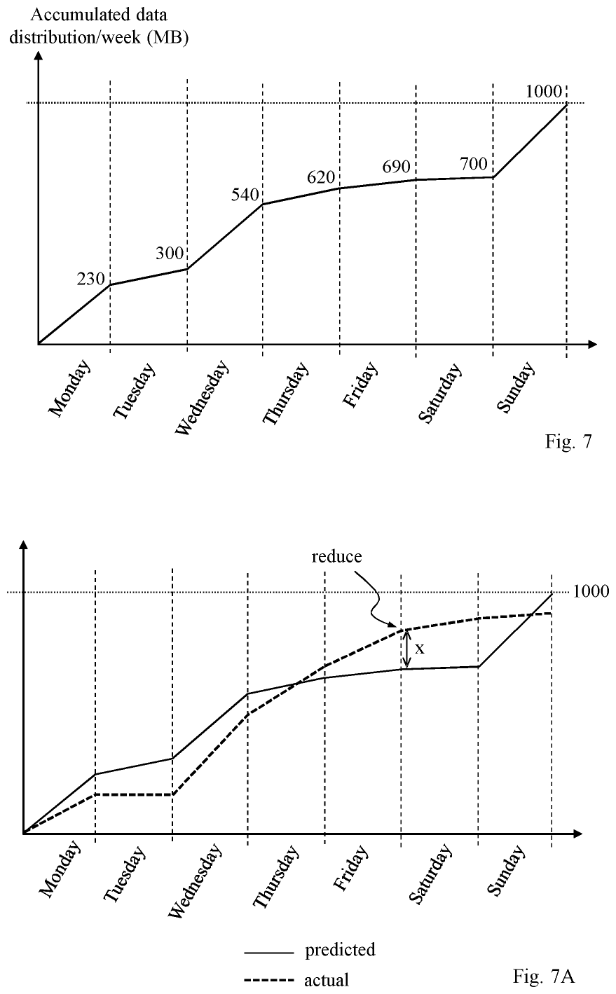

FIG. 7 illustrates how the predicted/suggested data amounts in FIG. 6 would be accumulated over a week, starting with 230 MB on Monday, 230+70=300 MB on Tuesday, 300+240=540 MB on Wednesday, and so forth. FIG. 7 thus illustrates a PDD determined from the measurements of FIG. 5.

FIG. 7A further illustrates how an actual measured data consumption, dashed line, can be compared to the PDD of FIG. 7, full line. It can be seen that after Wednesday the actual data consumption is somewhat below the predicted one and no measures need to be taken yet to reduce the requested amount of data. However, after Friday it is detected that the actual data consumption exceeds the predicted one by a margin x, corresponding to Yes in action 402, which triggers the above-described actions 304/408 of reducing the requested amount of data, unless the data saving function is currently inactive. After Thursday the actual data consumption exceeds the predicted one by a small value that is less than the margin x and the data reduction is therefore not triggered then, so as to avoid a ping-pong like initiation and stopping of the data reduction.

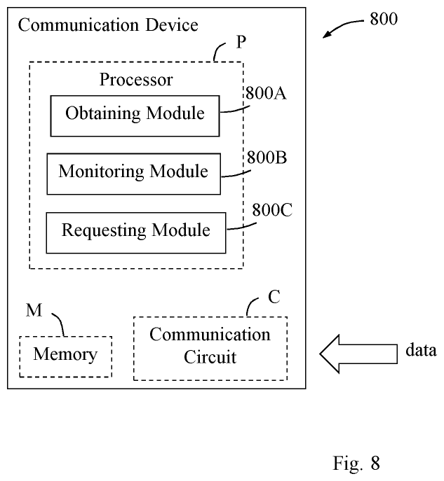

The block diagram in FIG. 8 illustrates a detailed but non-limiting example of how a communication device 800 may be structured to bring about the above-described solution and embodiments thereof. The communication device 800 may be configured to operate according to any of the examples and embodiments for employing the solution as described herein, where appropriate and as follows. The communication device 800 is shown to comprise a processor P and a memory M, said memory comprising instructions executable by the processor P whereby the communication device 800 is operable as described herein. The communication device 800 also comprises a communication circuit C with suitable equipment for receiving and sending information and data in the manner described herein.

The communication device 800 corresponds to the communication device 200 in FIG. 2. The communication circuit C may be configured for requesting and receiving data from one or more data sources, using suitable protocols and messages. The solution and embodiments herein are not limited to using any specific types of messages or protocols for the above communication.

The communication device 800 comprises means configured or arranged to basically perform at least some of the actions in FIGS. 3 and 4, and more or less as described above for the communication device 200 in various examples and embodiments. In FIG. 8, the communication device 800 is arranged or configured to control reception of data in the communication device 800 when a maximum total amount of received data is stipulated for a time period, as follows.

The communication device 800 is configured to obtain a predicted distribution of data that the communication device is expected to receive over said time period without exceeding said maximum total amount of data. This operation may be performed by an obtaining module 800A in the communication device 800, e.g. in the manner described above for action 300. The obtaining module 800A could alternatively be named a machine learning module or training module.

The communication device 800 is further configured to monitor an amount of data received during said time period. This operation may be performed by a monitoring module 800B in the communication device 800, e.g. as described above for action 302. The monitoring module 800B could alternatively be named a measuring module or metering module.

The communication device 800 is also configured to reduce an amount of requested data when detecting that the monitored amount of received data exceeds the predicted distribution of data, so that the maximum total amount of received data will not be exceeded before said time period expires. This operation may be performed by a requesting module 800C in the communication device 800, e.g. as described above for action 304.

It should be noted that FIG. 8 illustrates various functional modules or units in the communication device 800, and the skilled person is able to implement these functional modules in practice using suitable software and hardware. Thus, the solution is generally not limited to the shown structures of the communication device 800, and the functional modules or units 800A-C therein may be configured to operate according to any of the features and embodiments described in this disclosure, where appropriate.

The functional modules or units 800A-C described above could thus be implemented in the communication device 800 by means of hardware and program modules of a computer program comprising code means which, when run by the processor P, causes the communication device 800 to perform at least some of the above-described actions and procedures.

In FIG. 8, the processor P may comprise a single Central Processing Unit (CPU), or could comprise two or more processing units such as CPUs. For example, the processor P may include a general purpose microprocessor, an instruction set processor and/or related chip sets and/or a special purpose microprocessor such as an Application Specific Integrated Circuit (ASIC). The processor P may also comprise a storage for caching purposes.

Each computer program may be carried by a computer program product in the communication device 800 in the form of a memory M having a computer readable medium and being connected to the processor P. The computer program product or memory in the communication device 800 may thus comprise a computer readable medium on which the computer program is stored e.g. in the form of computer program modules or the like. For example, the memory M may be a flash memory, a Random-Access Memory (RAM), a Read-Only Memory (ROM), an Electrically Erasable Programmable ROM (EEPROM) or Hard Drive storage (HDD), and the program modules could in alternative embodiments be distributed on different computer program products in the form of memories within the communication device 800.

The solution described herein may thus be implemented in the communication device 800 by a computer program comprising instructions which, when executed on at least one processor, cause the at least one processor to carry out the actions according to any of the above embodiments and examples, where appropriate. The solution may also be implemented in a carrier containing the above computer program, wherein the carrier is one of an electronic signal, an optical signal, a radio signal, or a computer readable storage product or computer program product.

While the solution has been described with reference to specific exemplifying embodiments, the description is generally only intended to illustrate the inventive concept and should not be taken as limiting the scope of the solution. For example, the terms “communication device”, “data”, “distribution of data”, “machine learning algorithm”, “cloud/network node” and “alert” have been used throughout this disclosure, although any other corresponding entities, functions, and/or parameters could also be used having the features and characteristics described here. The solution is defined by the appended claims.

1-27. (canceled)

28. A method for controlling reception of data in a communication device when a maximum total amount of received data is stipulated for a time period, the method comprising:
obtaining a predicted distribution of data that the communication device is expected to receive over the time period without exceeding the maximum total amount of data;
monitoring an amount of data received during the time period; and
reducing an amount of requested data when detecting that the monitored amount of received data exceeds the predicted distribution of data, so that the maximum total amount of received data will not be exceeded before the time period expires.

29. The method of claim 28, wherein reducing the amount of requested data comprises:
requesting data with reduced bitrate;
requesting compressed data;
requesting only relevant data while omitting non-relevant data;
requesting data with reduced resolution; and/or
notifying a user to restrict consumption of data.

30. The method of claim 28, wherein the predicted distribution of data is obtained by applying a machine learning algorithm on previously received amounts of data.

31. The method of claim 28, wherein the predicted distribution of data is obtained from a cloud or network node where a machine learning algorithm is applied on previously received amounts of data.

32. The method of claim 28, wherein the amount of requested data is reduced in response to detecting that the monitored amount of received data exceeds the predicted distribution of data by a certain margin.

33. The method of claim 28, wherein the predicted distribution of data comprises an expected amount of received data per individual day during the time period.

34. The method of claim 28, wherein the time period has a duration of one month.

35. The method of claim 28, further comprising the communication device issuing an alert to notify a user that the maximum total amount of received data is likely to be exceeded before the time period expires.

36. The method of claim 35, wherein the alert indicates an amount of remaining data that can be received until the time period expires without exceeding the stipulated maximum amount of data.

37. The method of claim 28, wherein the reducing the amount of requested data is performed when a data saving function in the communication device is active.

38. The method of claim 37, wherein the data saving function comprises multiple selectable levels of data reduction determining how much requested data to reduce.

39. The method of claim 37, wherein the data saving function is offered by the communication device as a visual and/or audio indication.

40. A communication device configured to control reception of data in the communication device when a maximum total amount of received data is stipulated for a time period, wherein the communication device comprises:
processing circuitry;
memory containing instructions executable by the processing circuitry whereby the communication device is operative to:
obtain a predicted distribution of data that the communication device is expected to receive over the time period without exceeding the maximum total amount of data;
monitor an amount of data received during the time period; and
reduce an amount of requested data when detecting that the monitored amount of received data exceeds the predicted distribution of data, so that the maximum total amount of received data will not be exceeded before the time period expires.

41. The communication device of claim 40, wherein the instructions are such that communication device is operative to reduce the amount of requested data by:
requesting data with reduced bitrate;
requesting compressed data;
requesting only relevant data while omitting non-relevant data;
requesting data with reduced resolution; and/or
notifying a user to restrict consumption of data.

42. The communication device of claim 40, wherein the instructions are such that communication device is operative to obtain the predicted distribution of data by applying a machine learning algorithm on previously received amounts of data.

43. The communication device of claim 40, wherein the instructions are such that communication device is operative to obtain the predicted distribution of data from a cloud or network node where a machine learning algorithm is applied on previously received amounts of data.

44. The communication device of claim 40, wherein the instructions are such that communication device is operative to reduce the amount of requested data in response to detecting that the monitored amount of received data exceeds the predicted distribution of data by a certain margin.

45. The communication device of claim 40, wherein the predicted distribution of data comprises an expected amount of received data per individual day during the time period.

46. The communication device of claim 40, wherein the instructions are such that communication device is operative to issue an alert to notify a user that the maximum total amount of received data is likely to be exceeded before the time period expires.

47. A non-transitory computer readable recording medium storing a computer program product for controlling reception of data in a communication device when a maximum total amount of received data is stipulated for a time period, the computer program product comprising program instructions which, when run on processing circuitry of an apparatus, causes the apparatus to:
obtain a predicted distribution of data that the communication device is expected to receive over the time period without exceeding the maximum total amount of data;
monitor an amount of data received during the time period; and
reduce an amount of requested data when detecting that the monitored amount of received data exceeds the predicted distribution of data, so that the maximum total amount of received data will not be exceeded before the time period expires.
